(19) United States
(12) Patent Application Publication
(10) Pub. No.: US 2006/0071492 A1
(43) Pub. Date: Apr. 6, 2006

(54) Fender finder

(76) Inventor: Alan S. Ganz, Chicago, IL (US)

Correspondence Address: John W. Hayes, P.O. Box 365, Arlington Heights, IL, 60006-0365, US

(21) Appl. No.: 10/957,934

(22) Filed: Oct. 4, 2004

(51) Int. Cl. B60R 19/00

(52) U.S. Cl. 296/1.07

(57) ABSTRACT

A fender finder that includes a vertical standard threaded over at least a portion of its exterior and designed for installation into a receiver portion threaded over at least a portion of its interior. In one form of the invention, the receiver portion is affixed by adhesive within an opening in the upper surface of a vehicle bumper. The vertical standard is then threaded into the receiver portion. The vehicle operator can easily see the vertical standard, whereas the vehicle hood and fenders are virtually invisible to the driver of many recent automobile models. The fender finder informs the vehicle driver about the location of vehicle extremities, thus facilitating the processes of parking, driving along narrow thoroughfares, and positioning the vehicle within a traffic lane while cruising along the highway.

### FIELD OF THE INVENTION

This invention relates generally to a device that aids a driver in locating vehicle extremities and in particular to a device that aids in locating the front fenders of a vehicle, and is more particularly directed toward a vehicle-mounted device that aids in locating vehicle front fenders both to facilitate parking the vehicle and positioning the vehicle properly in its traffic lane while in motion.

### BACKGROUND OF THE INVENTION

For many years, the prominent front-end decoration or “hood ornament” provided on automobiles not only served to identify the vehicle manufacturer, but also provided a reference point for the driver in determining the vehicle's position in the traffic lane while motoring. For many modern automobile models, the hood ornament has been dispensed with, and the loss of this valuable reference point has made the task of maintaining proper position in a traffic lane more challenging for many drivers.

It is not only the loss of the hood ornament that creates position problems for drivers. In the past, automakers sold cars with front fenders that could be seen by the driver. Today, many new car models, particularly mid-size and compact, are designed such that the vehicle front slopes sharply down and away from the driver. In some cases, the driver can only see the windshield wipers. Even for drivers of greater than average height, the leading edge of the vehicle hood cannot be seen at all from the driver's seat. To make matters worse, the front fenders of the car are also invisible. Without a visible marker indicating the center of the hood, and without the driver being able to determine with certainty the precise position of the vehicle fenders, keeping the vehicle centrally positioned within its traffic lane is largely based upon approximation, and parallel-parking the vehicle, even in a spacious parking spot, can be problematic.

There are a number of “fender guide” devices known in the art. For example, U.S. Pat. No. 1,834,682, issued Dec. 1, 1931 to Charles Colstad, describes a guiding attachment for automobiles. This particular type of fender guide is attached to the vehicle by clamping to a fender. The staff of the fender guide is mounted on a pivot so that the orientation of the staff can be adjusted to vertical no matter what angle the base portion makes with the fender. An indicator, such as a bird or an arrow, is screwed on to the top of the staff to make the fender guide easy to see for the driver.

U.S. Pat. No. 2,584,777 issued Feb. 5, 1952 to Mr. George S. Adolfson. Mr. Adolfson's invention is a clearance-indicating arm that is pivotally mounted to the interior of an automobile windshield by a suction cup. The arm is formed from clear plastic and is softly illuminated at night so it can be plainly seen by the driver. In operation, the guide is pivoted into a position parallel with the highway center line, and the operator uses the guide as an aid in preventing drifting of the vehicle across the center line.

U.S. Pat. No. 2,559,761 issued Jul. 10, 1951 to Frank F. Fulton, describes a tractor sight designed to make it easier for a tractor driver to drive the vehicle in a straight line when sighting on a distant indicator (generally a tall post). The sighting portion of Mr. Fulton's invention is generally circular in nature, and includes two spaced-apart vertical bars through which the distant post or marker is viewed by the driver for better alignment. Mr. Fulton's tractor sight uses a U-shaped bracket firmly mounted to the tractor hood, and includes a threaded stud protruding upwardly from the bracket. The vertical rod that supports the circular sight is manufactured in telescoping sections. The interior section is securely threaded onto the stud that projects upward from the mounting bracket, then the height of the circular sight portion above the tractor hood can be adjusted by moving the telescoping rod, then securing the outer-rod in place with respect to the inner rod with the aid of a winged set screw.

U.S. Pat. No. 2,753,439 issued Jul. 3, 1956 to Mr. Alec Greenfield. Mr. Greenfield's patent describes a vehicle clearance guide designed to be mounted directly to the frame surrounding the vehicle headlight. The mounting base is a clamping structure which, in one embodiment, has hook-like features that engage interior and exterior portions of the headlight lens frame. The clearance guide itself is a simple vertical rod fixed to the mounting base with a clamp that allows adjustment of the vertical extent of the rod itself. In another embodiment, the clearance-indicating rod has a light mounted at its top. An electrical connector is provided that is intended to be clipped onto the existing vehicle headlight connector.

U.S. Pat. No. 3,657,821, issued Apr. 25, 1972 to Peter A. De Nure, is directed toward a special vehicle orienting device that is designed to allow the vehicle operator to maintain the vehicle at a fixed distance from a reference line at the right-hand side of the roadway. This is a fairly simple plastic device, preferably spherical in design, that is simply attached to the vehicle hood close to the front of the vehicle. The precise position of this orienting device is dependent upon the particular vehicle operator and the desired distance the operator would like to maintain from the right-hand side of a roadway. The orienting device can also be illuminated by a lamp mounted underneath the vehicle hood, provided that an appropriate reflector and a second transparent opening in the hood are provided to direct light onto the orienting device.

U.S. Pat. No. 3,858,924 issued Jan. 7, 1975 to John F. Bores. This patent describes a truck bumper guide that can be mounted by a clamp-type mounting base that is easily affixed to the outward extremities of a truck bumper. The mounting base clamps a vertical mounting sleeve securely to the truck bumper. A vertical standard, including a light at the top for easy viewing by the driver, simply slides into the sleeve for proper mounting.

U.S. Pat. No. 4,016,653 issued Apr. 12, 1977 to Joseph E. Bartlett. This patent is directed toward another type of sighting device for a vehicle, which in this case is a telescoping shaft that is pivotally mounted at one end to the vehicle dashboard. The other end of this telescoping member supports a sight through which the operator can view the roadway centerline. The mounting shaft for this sight pivots and telescopes so that the position of the sight can be precisely adjusted.

U.S. Pat. No. 4,070,645, issued Jan. 24, 1978 to Mr. Jerome Oreluk, is directed toward a device designed for connection to the vehicle using the mounting holes for the front license plate. The device itself is a rod, mounted such that it extends slightly forward of true vertical. The device includes an electrical switch that is activated if the rod is moved toward the vertical position. The switch is normally coupled to the vehicle horn to give an audible indication of contact with a bumper of a vehicle in front. It can readily be appreciated that this device is intended to act as an aid in parking a vehicle when the precise location of the vehicle front bumper cannot easily be determined by the vehicle operator.

U.S. Pat. No. 4,928,393 issued May 29, 1990 to Wilbur Van Schaack. This patent is directed toward a lane marker steering guide designed to be mounted to the interior of a vehicle windshield using a suction cup. The operator of the vehicle simply sights along this indicator device to the road edge marker on the right-hand side of the highway, and maintains this position in order to keep the vehicle in the desire lane. There are a number of embodiments described, including the use of multiple suction cups and other adjustment features to allow the indicator to be repositioned for various drivers of the vehicle.

U.S. Pat. No. 5,094,001 issued Mar. 10, 1992 to Rodney Fraser, and is directed toward a transversely extending sighting device designed to be mounted to the hood of a tractor. The horizontally disposed rod is telescopically extendable and includes sighting markers disposed along its length to assist in navigating various courses through a field.

U.S. Pat. No. 5,826,966 issued Oct. 27, 1998 to John Schwing. This particular patent is directed toward a lighted bumper guide that has a base portion designed to be affixed to the bumper of a vehicle. The base portion includes a light source, and the vertical portion that attaches to the base includes a fiber optic filament to direct illumination.

U.S. Pat. No. 2,218,486 issued Oct. 15, 1940 to Mr. William Storrie. This invention is a fender guide designed to be mounted to a vehicle fender so that it extends both vertically and in a forward direction from its mounting point. This forward inclination is incorporated so that an indicator at the top of the shaft (visible to the operator of the vehicle) will be positioned at a point that is directly above the forward portion of the vehicle that is furthest from the driver. This method of identifying the furthest extremity of the vehicle is particularly useful when parking the vehicle in a small parking place closely bounded by other vehicles.

U.S. Pat. No. 2,553,963 issued May 22, 1951 to Mr. William Dzus. This patent is directed toward yet another steering guide designed for vehicles. Rather than being mounted along the vehicle centerline at the front of the vehicle, this particular steering guide is mounted on the vehicle hood directly in front of the driver. The inventor asserts that this particular mounting arrangement makes it much easier for the driver to accurately control the vehicle's position along the roadway.

The fender guides and aiming devices of the prior art are difficult or impossible to mount on modern auto bodies, particularly those with a high plastic or composite content in the front bumpers and fenders, and, since most of the devices in the art were developed long ago, they would not be considered esthetically pleasing today. Consequently, a need arises for a device that will aid the driver in determining the precise extent of the vehicle when parking (and when driving, particularly when navigating along narrow thoroughfares), and that will help establish a reference to ease the task of positioning the vehicle properly within its traffic lane when driving down the highway. The device should be unobtrusive, relatively low in cost, and both efficient and inexpensive of installation.

### SUMMARY OF THE INVENTION

These needs and others are satisfied by the fender finder of the present invention, which includes a vertical standard threaded over at least a portion of its exterior and designed for installation into a receiver portion threaded over at least a portion of its interior. In one form of the invention, the receiver portion is affixed by adhesive within an opening in the upper surface of a vehicle bumper or fender. The vertical standard is then threaded into the receiver portion. The vehicle operator can easily see the vertical standard on the right and left fenders or bumpers. Without the vertical standard, the vehicle hood and fenders are completely invisible to the driver. The fender finder informs the vehicle driver about the location of vehicle extremities, thus easing the processes of parking, driving along narrow thoroughfares, and positioning the vehicle within a traffic lane while cruising along the highway.

In accordance with one embodiment of the present invention, a locating device constructed and arranged for installation on a vehicle comprises an upright portion threaded along at least a part of its exterior surface and a receiver portion threaded along at least a part of its interior surface, the receiver portion designed to be affixed within an opening in the vehicle surface. The upright portion is screwed into the receiver portion to attach the upright portion and the receiver portion together, such that the upright portion is visible to the vehicle operator to aid in determining location of vehicle extremities.

In one form of the invention, the upright portion is formed from a non-metallic material, such as polyvinyl chloride or fiberglass. The upright portion may also be threaded along substantially its entire length. Preferably, the receiver portion is installed within a vertically oriented opening in the vehicle surface, and fixed in position with an adhesive. In a typical installation, the receiver portion is installed within the opening such that the upper extremity of the receiver portion is substantially flush with the opening. In another form of the invention, the upright portion is removable and replaceable by a plastic cap that substantially covers the opening in the vehicle surface and the receiver portion.

In another aspect of the invention, the receiver portion comprises an L-shaped structure having a receiver arm and an installation arm, wherein the receiver arm is threaded along at least a part of its interior surface, and the installation arm is threaded along at least a portion of its exterior surface. The installation arm of the receiver portion is designed to be affixed within an opening formed in the vehicle sidewall. In accordance with one embodiment of the invention, the installation arm of the receiver portion is affixed within the opening in a substantially horizontal orientation by a pair of spacers having opposing planar surfaces that make an angle with respect to one another that is approximately equal to the angle between the vertical and the vehicle surface proximate the opening. The receiver portion is fixed in an installed position by a pair of opposing lock nuts with the spacers disposed therebetween. There may also be resilient washers disposed between each spacer and the vehicle surface.

Further objects, features, and advantages of the present invention will become apparent from the following description and drawings.

### BRIEF DESCRIPTION OF THE DRAWINGS

FIG. 1 is a top plan view of a portion of an automobile, from the windshield to the front extremity;

FIG. 2 is a side elevational view of the automobile portion illustrated in FIG. 1;

FIG. 3 is a top view of a vertical standard in accordance with the present invention;

FIG. 4 is a side view of the vertical standard of FIG. 3;

FIG. 5 is a top view of a receiver in accordance with the present invention;

FIG. 6 is a side view of the receiver of FIG. 5;

FIG. 7 is a section view taken along section lines 7-7 of FIG. 5;

FIG. 8 is a cutaway view of a portion of a vehicle bumper illustrating installation of the receiver of FIG. 6;

FIG. 9 is a top view of a plastic cap;

FIG. 10 is a side view of the plastic cap of FIG. 9;

FIG. 11 depicts an alternative configuration in accordance with the present invention;

FIG. 12 is a side view of a spacer; and

FIG. 13 is an end view of the spacer of FIG. 12.

### DETAILED DESCRIPTION OF THE INVENTION

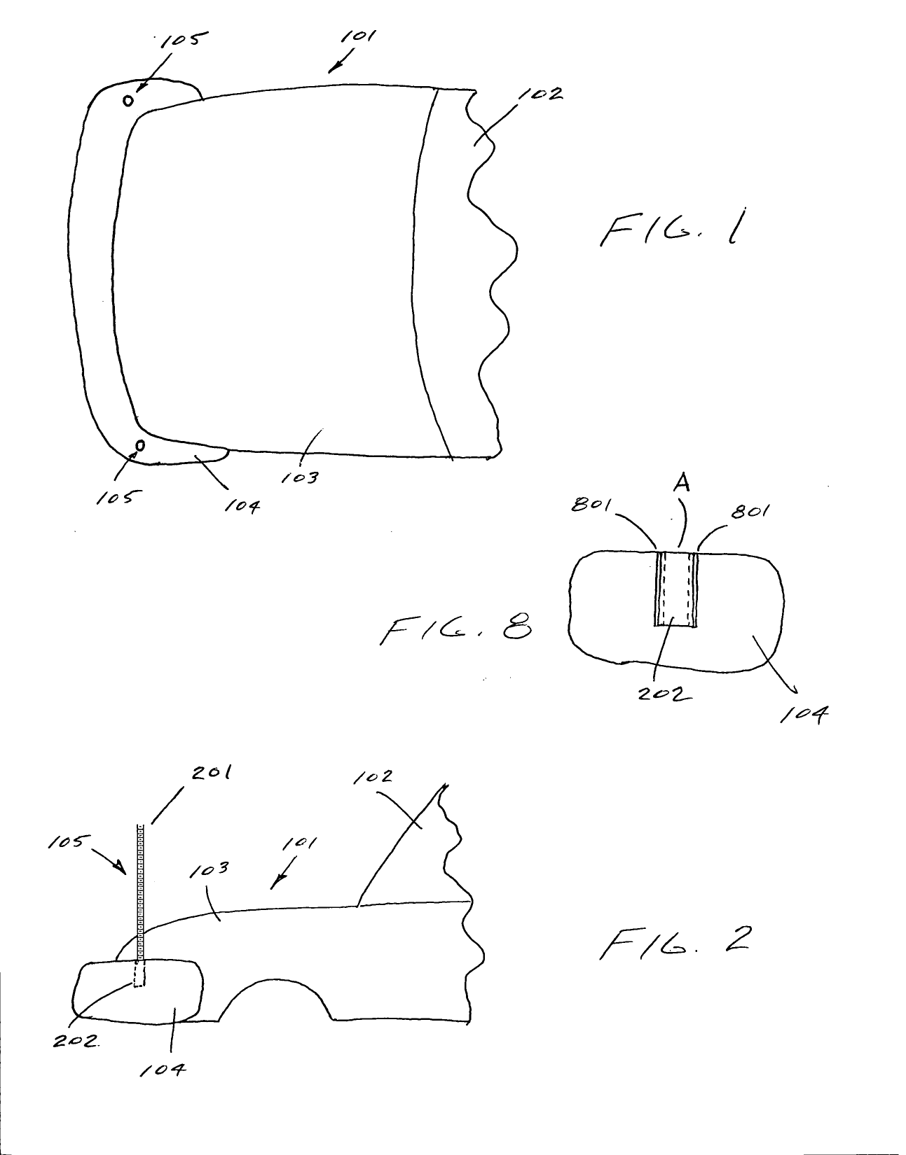

There is described herein a fender finder that offers distinct advantages when compared to the prior art. FIG. 1 is a top plan view of a portion of an automobile 101 that includes a hood portion 103 that slopes rapidly down and away from the driver's position behind the windshield 102, thus depriving the driver of any view of the hood or fenders. This particular vehicle hood 103 does not have a hood ornament.

The bumper 104 is of the type commonly employed on automobiles manufactured in recent years. Generally, these bumpers 104 are non-metallic, plastic composite constructions that may have a substantial layer of a foam material surrounded by thin plastic. The plastic covering does not contribute materially to the structural integrity of the vehicle bumper 104, but is primarily present for appearance sake. The vehicle illustrated in FIG. 1 is equipped with two fender finders 105 in accordance with the present invention.

FIG. 2 is a side elevational view of the automobile portion 101 illustrated in FIG. 1. One of the fender finders 105 is clearly visible in this view, and it will be appreciated that the fender finder 105 is generally comprises two portions: a vertical standard portion 201 and a receiver or anchor portion 202.

FIGS. 3 and 4 illustrate the standard 201 in greater detail. Preferably, the standard 201 is a solid non-metallic rod with an exterior thread. In one embodiment, the rod is fiberglass, but the rod may also be formed from a plastic compound such as PVC (polyvinyl chloride), for example, and the thread on the exterior surface may be extended over the entire length of the standard 201 for ease of manufacture. Of course, it is entirely possible to fabricate the standard from other suitable materials, such as a metal like stainless steel, for example, and it is equally possible to make the standard in the form of a hollow tube rather than a solid rod. However, there are a number of design considerations involved, such as weight, material and manufacturing costs, and wind resistance when a vehicle equipped with a fender finder 105 is driving down the highway at normal speed.

In any event, the color of the standard 201 is preferably white, or at least a light color so that the standard will be readily visible to the driver 201. If the standard 201 is plastic, it can be formed from a plastic material of the desired color. In the alternative, the standard 201 may be dipped, painted, coated, or otherwise imbued with any desired color, and a flag, pennant, or ornament may be affixed to the upper extremity of the standard at the user's discretion. An illuminated or reflectorized tip could even be added for enhanced visibility.

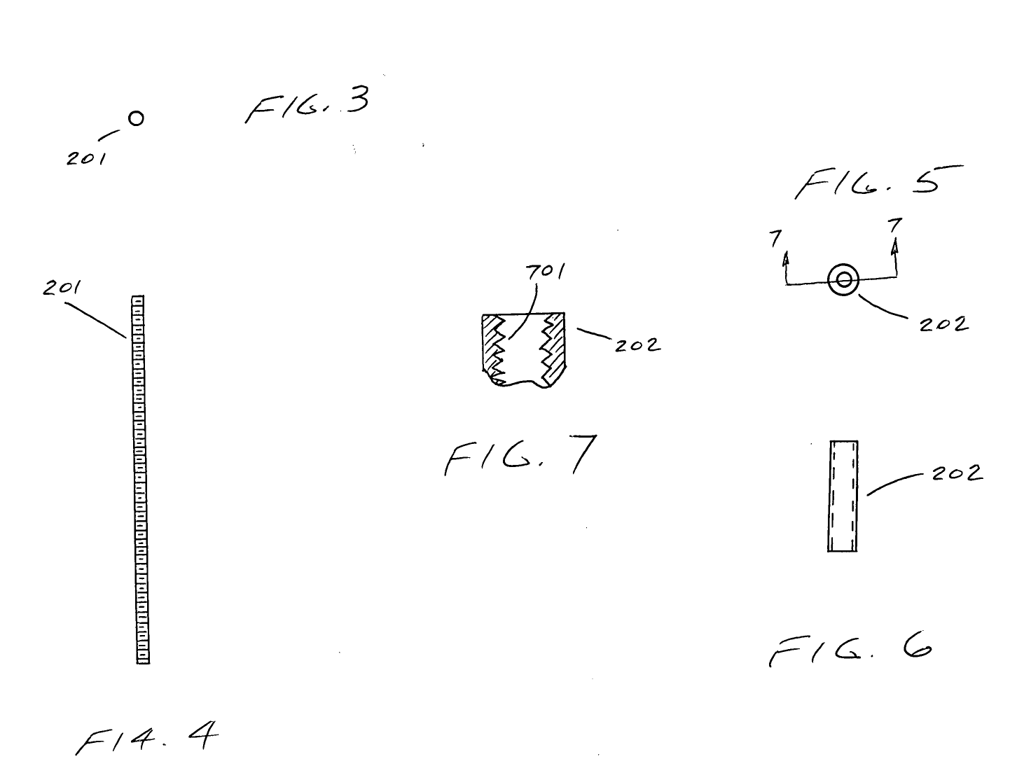

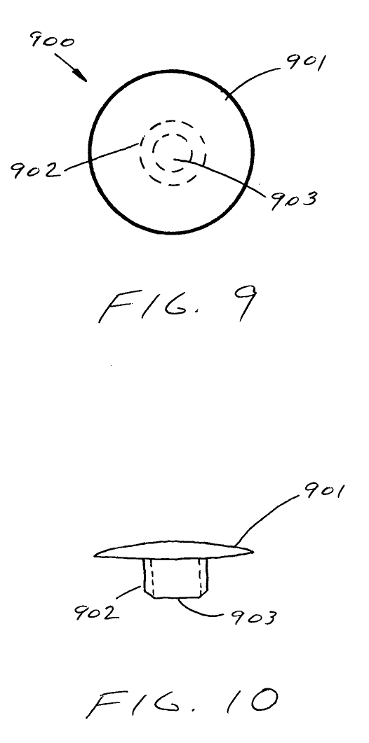

As noted with reference to FIG. 1, the standard 201 is installed into a receiver or anchor portion 202, which is illustrated in more detail in FIGS. 5 through 7. Preferably, the receiver 202 is formed from a sturdy non-metallic material, such as fiberglass or PVC, for example, and is provided with threads 701 in its interior. The threads may extend for the entire length of the receiver 202 or may end abruptly. In fact, although not illustrated in the drawing figures, a threaded portion (such as a nut) may simply be attached to the open end of the receiver, thus obviating interior threading of the receiver portion 202.

Of course, it may be advantageous to provide a ridge of material at the thread termination within the anchor body, to act as a stop for the standard (201 in FIG. 4), but this is not a requirement (and is not shown in the figures). It is also possible to add a lock nut on the standard itself, to be tightened against the anchor 202 when the standard is in its installed position, but this is also not required and is not illustrated. Another possible expedient is the introduction of an adhesive to the exterior of the standard 201, along the portion of the standard 201 that fits inside the receiver 202, so it will resist backing out of the receiver portion 202.

For ease of manufacture and cost considerations, the standard 201 itself is preferably cut to a length of 3 feet 6 inches. Of course, it is a simple matter to adjust the height of the standard 201 to suit a particular vehicle installation, by simply trimming off the excess. If the standard 201 is threaded throughout its length, then the threads themselves provide a convenient cut mark for any trimming that the installer may consider necessary.

FIG. 8 is a view of the receiver 202 in its installed position within the vehicle bumper 104. For installation, a hole is drilled in the vehicle bumper to a depth of 6 inches, which is the overall length of the receiver portion 202 as supplied. Of course, the length of the receiver can be adjusted, and the hole-drilling procedure modified for any particular installation. It is entirely possible that 6 inches of receiver 202 might be excessive for some vehicles. In any event, the hole in the vehicle structure is drilled such that, when installed, the upper edge of the receiver 202 will be flush with (or slightly below) the upper surface of the vehicle bumper 104.

After the hole in the bumper 104 has been prepared, a strong adhesive, such as an epoxy-based adhesive, is applied both to the outside of the receiver 202 and the interior of the hole in the bumper 104. The receiver 202 is inserted into the hole and the adhesive 801 is allowed to dry thoroughly before the standard 201 is threaded into place.

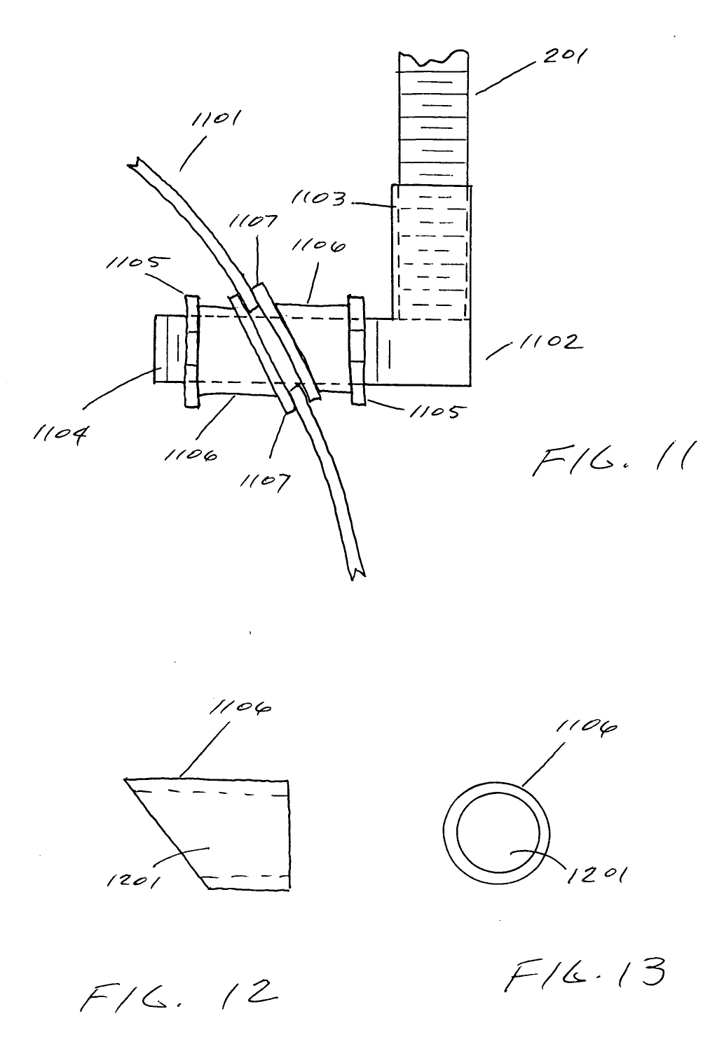

Of course, a powerful adhesive such as epoxy resin is nearly impossible to remove. Consequently, should the vehicle operator wish to discontinue use of the fender finder, the standard 201 may be unscrewed and removed. To cover the opening in the bumper 104, and the receiver 202 itself, cap 900 as illustrated in FIGS. 9 and 10 may be used. Preferably, the cap 900 is formed from a relatively flexible material, such as nylon, but the cap could be fabricated from other suitable materials, such as fiberglass, for example. As shown, the cap 900 includes an upper circular portion 901 have a great enough diameter to cover the opening in the bumper. A portion 902 extending downwardly from the upper portion 901 should provide a press fit into the threaded interior of the receiver 202 (FIG. 8), completely covering the opening A (FIG. 8). Returning to FIGS. 9 and 10, there is preferably an opening 903 provided in the downwardly extending portion 902 to enhance deformability. Of course, the cap 900 may be affixed in position using an adhesive. As an alternative, the cap may be replaced by a bolt having a thread that matches the thread of the receiver 202, although this alternative is not shown in the drawings. The bolt could be formed from metallic or non-metallic material.

FIG. 11 illustrates another mounting configuration for the fender finder. In this exemplary embodiment, the decision is made to attach the fender finder to the sloping exterior of the vehicle fender in a position proximate the front of the vehicle. This positioning is contemplated in cases where it is not feasible to attach the fender finder directly to the vehicle bumper.

In the mounting detail of FIG. 11, a right-angle receiver 1102 is used to accommodate the vertical standard 201. The right-angle receiver 1102 is preferably formed from fiberglass, PVC, or other durable non-metallic material, but metal, such as stainless steel, may be preferred for some installations. This right-angle receiver 1102 is substantially L-shaped, with a receiver arm oriented vertically and designed to accept the standard 201, and an installation arm oriented horizontally and designed to be inserted through an opening in the vehicle. Just as described previously, the receiver arm has a vertical portion with internal threads 1103 designed to accommodate the exterior threads of the standard 201.

In operation, an opening is made in the vehicle fender 1101 and the horizontal portion of the receiver 1102 is inserted through the opening. Prior to inserting the receiver 1102, a lock nut 1105 is turned onto the threaded horizontal shaft, a specially cut spacer 1106 is placed on the horizontal shaft of the receiver, and these are followed by a sealing grommet or washer 1107. This grommet or washer 1107 may be formed from rubber or other resilient material so that the grommets 1107 provide a sealing action.

The spacer 1106, illustrated in greater detail in FIGS. 12 and 13, may also be formed from plastic material, and is cut at an angle corresponding to the angle the fender 1101 makes with the vertical at the point where the opening is made. This specialized angle is necessary in order that the standard 201 will be as nearly vertical as possible when installed. Of course, the spacers 1106 may also be formed from a suitable metallic material.

After the horizontal portion of the receiver 1102 is inserted through the opening, another grommet or washer 1107, spacer 1106, and nut 1105 are placed on the horizontal shaft, and the whole is tightened firmly using the nuts 1105. Thus, the receiver 1102 is firmly fixed in position, and the standard 201 may be installed as described above for the prior embodiment.

There has been described herein a fender finder that offers distinct advantages when compared with the prior art. It will be apparent to those skilled in the art that modifications may be made without departing from the spirit and scope of the invention. Accordingly, it is not intended that the invention be limited except as may be necessary in view of the appended claims.

What is claimed is:

1. A locating device constructed and arranged for installation on a vehicle, the locating device comprising:
an upright portion threaded along at least a part of its exterior surface;
a receiver portion threaded along at least a part of its interior surface, the receiver portion designed to be affixed within an opening in the vehicle surface;
wherein the upright portion is screwed into the receiver portion to attach the upright portion and the receiver portion together, such that the upright portion is visible to the vehicle operator to aid in determining location of vehicle extremities.

2. The locating device of claim 1, wherein the upright portion is formed from a non-metallic material.

3. The locating device of claim 2, wherein the non-metallic material comprises fiberglass.

4. The locating device of claim 1, wherein the upright portion is threaded along substantially its entire length.

5. The locating device of claim 1, wherein the receiver portion is installed within a vertically oriented opening in the vehicle surface, and fixed in position with an adhesive.

6. The locating device of claim 1, wherein the receiver portion is installed within the opening such that the upper extremity of the receiver portion is substantially flush with the opening.

7. The locating device of claim 1, wherein the upright portion is removable and replaceable by a cap that substantially covers the opening in the vehicle surface and the receiver portion.

8. The locating device of claim 1, wherein the receiver portion comprises an L-shaped structure having a receiver arm and an installation arm, wherein the receiver arm is threaded along at least a part of its interior surface, and the installation arm is threaded along at least a portion of its exterior surface.

9. The locating device of claim 8, wherein the installation arm of the receiver portion is designed to be affixed within an opening formed in the vehicle sidewall.

10. The locating device of claim 9, wherein the installation arm of the receiver portion is affixed within the opening in a substantially horizontal orientation by a pair of spacers having opposing planar surfaces that make an angle with respect to one another that is approximately equal to the angle between the vertical and the vehicle surface proximate the opening.

11. The locating device of claim 10, wherein the receiver portion is fixed in an installed position by a pair of opposing lock nuts with the spacers disposed therebetween.

12. The locating device of claim 10, further comprising resilient washers disposed between each spacer and the vehicle surface.

13. A locating device constructed and arranged for installation on a vehicle, the locating device comprising:
an upright portion comprising a rod of non-metallic material threaded along substantially all of its exterior surface;
a substantially cylindrical receiver portion threaded along at least a part of its interior surface, the receiver portion designed to be affixed within a substantially vertically oriented opening in the vehicle surface and substantially flush with the opening, and fixed in position with an adhesive;
wherein the upright portion is screwed into the receiver portion to attach the upright portion and the receiver portion together, such that the upright portion is visible to the vehicle operator to aid in determining location of vehicle extremities.

14. The locating device of claim 13, wherein the upright portion is removable and replaceable by a cap that substantially covers the opening in the vehicle surface and the receiver portion.

15. A locating device constructed and arranged for installation on a vehicle, the locating device comprising:
an upright portion threaded along at least a part of its exterior surface;
a receiver portion comprising an L-shaped structure having a receiver arm and an installation arm, wherein the receiver arm is threaded along at least a part of its interior surface, and the installation arm is threaded along at least a portion of its exterior surface;
wherein the upright portion is screwed into the receiver portion to attach the upright portion and the receiver portion together, such that the upright portion is visible to the vehicle operator to aid in determining location of vehicle extremities.

16. The locating device of claim 15, wherein the installation arm of the receiver portion is designed to be affixed within an opening formed in the vehicle sidewall.

17. The locating device of claim 16, wherein the installation arm of the receiver portion is affixed within the opening in a substantially horizontal orientation by a pair of spacers having opposing planar surfaces that make an angle with respect to one another that is approximately equal to the angle between the vertical and the vehicle surface proximate the opening.

18. The locating device of claim 17, wherein the receiver portion is fixed in an installed position by a pair of opposing lock nuts with the spacers disposed therebetween.

19. The locating device of claim 17, further comprising resilient washers disposed between each spacer and the vehicle surface.

20. The locating device of claim 15, wherein the upright portion comprises a rod of non-metallic material threaded along substantially its entire length.
